(19) United States
(12) Patent Application Publication
(10) Pub. No.: US 2026/0245141 A1
(43) Pub. Date: Aug. 20, 2026

(54) SPEECH SIGNAL PROCESSING BY ARTIFICIAL INTELLIGENCE-BASED NATURAL LANGUAGE HUB

(71) Applicant: Truist Bank, Charlotte, NC (US)

(72) Inventors: Kristen Helen Martin, Charlotte, NC (US); WeiJen Lu, Raleigh, NC (US)

(73) Assignee: Truist Bank, Charlotte, NC (US)

(21) Appl. No.: 19/054,973

(22) Filed: Feb. 17, 2025

(51) Int. Cl. G06Q 40/02; G06F 40/56

(52) U.S. Cl. CPC G06Q 40/02; G06F 40/56

(57) ABSTRACT

Methods, computer-readable storage media, and apparatuses facilitate generating and utilizing natural language recommendations based on client data. An application operating on a processor accesses data related to the client's internal and external accounts from multiple sources. The application integrates this data and uses an artificial intelligence (AI) model to analyze the aggregated data. Based on the analysis and various application features, a natural language recommendation is generated. The application creates a graphical user interface displaying indications of the features and the recommendation. When the recommendation is selected, the application performs an operation linked to a specified feature.

### BACKGROUND

Conventional systems require different user accounts to be managed and maintained by a single entity. Because these systems siloed client data, application features are conventionally limited to leveraging the data available within a single silo. Therefore, users of these systems must maintain these disparate accounts and are not able to view their accounts in an aggregated, holistic hub. Furthermore, these users cannot receive tailored insights or recommendations that consider all of their data.

### BRIEF SUMMARY

In some embodiments, a method involves an application accessing data related to one or more of a client's internal accounts and receiving data about multiple external accounts from various data sources. This data is aggregated by the application, and an AI model analyzes the aggregated data. Based on the analysis and application features, the AI model creates a first natural language recommendation using a specific application feature. The application generates a graphical user interface that includes indications of the application's features and the recommendation. User input selects the recommendation, which prompts the application to carry out an operation using the designated feature.

In other embodiments, a non-transitory computer-readable storage medium includes instructions that, when executed by a processor, enable the processor to perform the same series of operations as described, including accessing, receiving, aggregating, analyzing, and generating recommendations, as well as user interface interactions and initiating operations.

In yet another embodiment, an apparatus contains a processor and memory that store instructions. When these instructions are executed by the processor, they enable the apparatus to access client account data, receive data from multiple external data sources, aggregate received data, analyze using an AI model, and generate recommendations and a corresponding graphical user interface. The apparatus also responds to user input by initiating the performance of an operation affiliated with a feature of the application.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4A illustrates an aspect of the subject matter in accordance with one embodiment.

FIG. 4B illustrates an aspect of the subject matter in accordance with one embodiment.

FIG. 5A illustrates an aspect of the subject matter in accordance with one embodiment.

FIG. 5B illustrates an aspect of the subject matter in accordance with one embodiment.

FIG. 5C illustrates an aspect of the subject matter in accordance with one embodiment.

FIG. 6A illustrates an aspect of the subject matter in accordance with one embodiment.

FIG. 6B illustrates an aspect of the subject matter in accordance with one embodiment.

FIG. 7 illustrates an aspect of the subject matter in accordance with one embodiment.

FIG. 8 illustrates a logic flow 800 in accordance with one embodiment.

FIG. 9 illustrates a logic flow 900 in accordance with one embodiment.

FIG. 10A is a diagram of a feedforward network, according to at least one embodiment, utilized in machine learning.

FIG. 10B is a diagram of a convolutional neural network, according to at least one embodiment, utilized in machine learning.

FIG. 10C is a diagram of a portion of the convolutional neural network of FIG. 10B, according to at least one embodiment, illustrating assigned weights at connections or neurons.

FIG. 11 is a diagram representing an exemplary weighted sum computation in a node in an artificial neural network.

FIG. 12 is a diagram of a Recurrent Neural Network (RNN), according to at least one embodiment, utilized in machine learning.

FIG. 13 is a schematic logic diagram of an artificial intelligence program including a front-end and a back-end algorithm.

FIG. 14 is a flow chart representing a method, according to at least one embodiment, of model development and deployment by machine learning.

FIG. 15 illustrates a computing system 1500 in accordance with one embodiment.

### DETAILED DESCRIPTION

Embodiments disclosed herein provide a comprehensive financial management platform that aggregates data from various accounts, including internal accounts and external accounts, to provide users with a holistic view of their financial status. For example, a first financial institution may provide the comprehensive financial management platform. A user having one or more accounts with the first financial institution may link other external accounts, e.g., accounts at other financial institutions, lenders, payroll services, etc. The data from these external accounts may be aggregated by the first financial institution and stored for analysis. For example, artificial intelligence programs may be used to analyze the data and generate one or more recommendations, natural language responses in an AI-based chat, etc. More generally, embodiments disclosed herein provide integrated tools and capabilities for consultative financial advice, predictive insights, and personalized journeys, which strengthen client trust, grow primacy, and fuel account opening.

More generally, by providing a comprehensive financial hub that aggregates data from sources, users are able to view and manage their finances in one place. By including AI-powered features, embodiments disclosed herein may analyze external data to offer personalized financial advice and product recommendations. The AI features may generate proactive suggestions such as refinancing mortgages, transferring balances, and/or optimizing savings based on the user's financial behavior and goals. As other examples, the AI features may project cash flow, identify spending patterns, and provide tailored financial advice. Using AI to generate insights from aggregated data may help users understand their financial situation better and make informed decisions.

Furthermore, embodiments disclosed herein may streamline processes such as external transfers and bill payments, making it easier for users to manage their finances. For example, users may transfer money between accounts with a single click, and the system will automatically handle the transaction. In some embodiments, advanced spending management tools may categorize transactions, track spending patterns, and provide insights into financial behavior. Users may receive alerts and tips on managing their expenses, such as identifying opportunities to save on recurring bills or adjusting budgets based on historical spending data.

In some embodiments, the platform may incorporate external data sources, including credit scores and financial goals, to enhance the accuracy and relevance of its recommendations. Such integrations may enable more robust pre-screening and pre-qualification processes for financial products. By continuously analyzing user data, embodiments disclosed herein may identify opportunities to deepen client relationships through targeted offers and personalized communication. This includes leveraging insights from transaction data to suggest relevant financial products and services.

In some embodiments, a mobile-first approach is provided, enabling users to manage their finances anytime, anywhere. This includes ensuring data integrity and optimizing the experience with real-time balances, customized aggregation flow, and clearer error guidance. Embodiments disclosed herein encourage clients to comprehensively manage their finances by incorporating aggregated accounts directly on a consolidated dashboard, integrating aggregated accounts within personalized insights, and delivering automated, customized financial analysis.

Embodiments disclosed herein are secure and compliant, as techniques for ensuring the security of user data and compliance with regulatory requirements are integrated into the system. The platform implement robust security measures to protect user credentials and account information during transmission and storage.

In some embodiments, the platform may feature an enhanced planning dashboard with interactive widgets, pre-filled goal-setting options, personalized financial wellness articles, and top-rated planning insights to enrich the digital client experience. One example is a net worth widget to provide users with a comprehensive view of their financial health, including assets and liabilities. As another example, a cash flow dashboard may be specifically designed for small businesses, promoting the use of tools with customizable settings.

In some embodiments, the platform may integrate financial planning tools and insights, allowing users to create digital plans and engage with financial advisors. Similarly, embodiments disclosed herein may provide proactive spending and budget tracking. For example, the platform may offer proactive spending and budget tracking features, including auto-saving and fee-saving insights for products.

In some embodiments, the platform may provide life journey guidance with specified goals, linking user needs with products and promoting active planning insights. Similarly, the platform may enable self-service management of online banking credentials used by third-party aggregators, ensuring user control and security. In some embodiments, onboarding enhancements are offered to drive engagement and provide personalized marketing offers based on user data.

Advantageously, embodiments disclosed herein revolutionize personal financial management by providing a seamless, integrated, and intelligent platform that empowers users to achieve their financial goals with minimal effort. The combination of comprehensive data aggregation, AI-driven recommendations, and automated self-service features provide cutting-edge solutions in the financial technology space. Doing so improves conventional systems, which lacked similar features. Therefore, systems implementing the functionality described herein may improve the functioning of computing systems used to manage or otherwise access various accounts.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

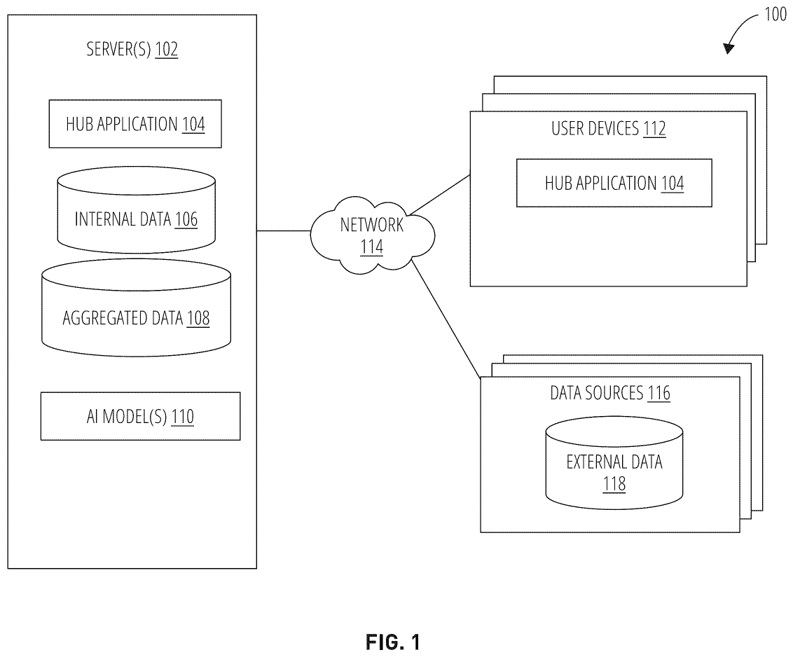

FIG. 1 illustrates a system 100 according to one embodiment. As shown, the system 100 includes one or more servers 102, one or more user devices 112, and a plurality of data sources 116 communicably coupled via one or more networks 114. The servers 102, user devices 112, and data sources 116 are representative of any type of physical and/or virtualized computing system. The servers 102, user devices 112, and data sources 116 each include at least one processor for executing instructions and at least one memory for storing instructions, each not pictured for the sake of clarity.

As shown, the server 102 includes a hub application 104, which is generally configured to provide a comprehensive financial management platform. In some embodiments, the hub application 104 is provided by an entity such as a financial institution. In such embodiments, user accounts, user profiles, transaction histories, account information, and any other data associated with the financial institution may be stored as internal data 106. As part of the comprehensive financial management platform, the hub application 104 may receive and leverage data from the data sources 116. The data sources 116 are representative of any type of data source, such as other financial institutions, credit agencies (also referred to as credit bureaus), lending agencies, government agencies, educational institutions, businesses, healthcare providers, insurance agencies, brokerages, social media platforms, etc.

As shown, the data sources 116 may store or otherwise manage external data 118. The external data 118 is representative of any type of data, such as account data, biographic data, transaction data, marketing data, insights, etc. For example, financial institutions may provide external data 118 including account balances, transaction histories, account types, interest rates, loan details, credit card information. As another example, credit bureaus may provide external data 118 including credit scores, credit reports, credit inquiries, and credit utilization data. As another example, investment firms may provide external data 118 including portfolio balances, transaction histories, investment types, performance metrics, and dividend information. Similarly, insurance companies may provide external data 118 including policy details, premium payments, claim histories, and coverage information. Government agencies may provide external data 118 including tax records, social security benefits, pension details, etc. Payroll providers may provide external data 118 including salary information, pay stubs, tax withholdings, and direct deposit details. Utility companies, telecommunication providers, and other companies may provide external data 118 including billing statements, payment histories, usage data, and service agreements. Retailers and loyalty programs may provide external data 118 including purchase histories, reward points, membership details, and promotional offers. Real estate platforms may provide external data 118 including property values, mortgage details, rental agreements, and transaction histories.

Healthcare providers may provide external data 118 including medical bills, insurance claims, payment histories, and coverage details, while educational institutions provide student loan details, tuition payments, scholarship information, and financial aid records. Cryptocurrency exchanges may provide external data 118 including wallet balances, transaction histories, exchange rates, and investment details. Financial planning tools may provide external data 118 including budgeting information, financial goals, spending patterns, and savings plans. Social media platforms may provide external data 118 including user profiles, activity logs, and engagement metrics. Embodiments are not limited in these contexts, as the external data 118 may store any number and type of data, or any combination of the aforementioned data types.

Generally, a user of the hub application 104 may provide authentication credentials to access their account and/or profile in the internal data 106. The hub application 104 may verify the authentication credentials. Once authenticated, the user may further provide, to the hub application 104, authentication credentials for one or more accounts with the data sources 116. For example, the user may provide a login and password, account number, token, etc., for each of a plurality of other accounts associated with the data sources. The hub application 104 may store the credentials in the internal data 106 and use the credentials to access the external data 118 of the other data sources 116 at predetermined time intervals (e.g., daily, weekly, monthly, etc.). By providing the respective credentials to the corresponding data source 116, the data source 116 may authenticate the credentials and provide external data 118 to the hub application 104 based on the authentication. By maintaining the credentials, the hub application 104 may periodically request and receive new external data 118 from the data sources 116 at predetermined time intervals.

Once received, the hub application 104 may store the external data 118 as the aggregated data 108. In some embodiments, the aggregated data 108 includes at least a portion of the internal data 106 and the external data 118 received from the data sources. In some embodiments, the hub application 104 may preprocess the external data 118 before storage in the aggregated data 108 (e.g., to format the data according to one or more data formats, standardizing the data, normalizing the data, etc.). In some embodiments, the system 100 provides one or more application programming interfaces (APIs) to facilitate the transfer of external data 118. For example, such APIs may include open banking APIs.

The hub application 104 may further leverage one or more AI models 110 to provide recommendations, insights, chat features, etc. Although depicted as being external to the hub application 104, in some embodiments, one or more of the AI models 110 are components of the hub application 104. The AI models 110 may be any type of artificial intelligence model, such as a machine learning model, neural network, large language model (LLM), etc. For example, the AI models 110 may include an LLM to provide an AI chatbot. The AI chatbot may output recommendations, converse with the user, answer questions, classify transactions, etc. As other examples, the AI models 110 may generate proactive suggestions for refinancing mortgages, transferring balances, and/or optimizing savings based on the user's financial behavior and goals. In addition and/or alternatively, the AI models 110 may project cash flow, identify spending patterns, and provide tailored financial advice. In some embodiments, the AI models 110 include models to process speech signals received as input, e.g., speech recorded by a microphone (not pictured) of user devices 112. For example, the AI models 110 may convert speech to text or otherwise process the speech signals, e.g., to determine intent, concepts, etc. Doing so may allow users to communicate with the hub application 104 and/or AI models 110 using speech.

In some embodiments, the AI models 110 may provide different types of output. For example, consider a user who has an account with the financial institution. The AI models 110 may use the aggregated data 108 to generate one or more recommendations, such as to open a credit card with the financial institution. Advantageously, the AI models 110 may generate a recommendation specifically for the customer to recommend that the customer opens the credit card. Similarly, the AI models 110 may generate a recommendation that is for the employees of the financial institution. For example, the AI models 110 may generate a recommendation to a salesperson to contact the user to discuss opening a credit card account. Embodiments are not limited in these contexts.

The hub application 104 may streamline processes such as external transfers and bill payments, making it easier for users to manage their finances. For example, a user of the hub application 104 may transfer money between accounts (whether internal or external accounts) with a single click, and the system 100 will automatically handle the transaction.

In some embodiments, the hub application 104 may provide advanced spending management tools, e.g., to categorize transactions, track spending patterns, and provide insights into financial behavior. In some embodiments, the hub application 104 may provide users alerts and tips on managing their expenses, such as identifying opportunities to save on recurring bills or adjusting budgets based on historical spending data.

As stated, the hub application 104 by leveraging the aggregated data 108, the hub application 104 incorporates external data 118 from the data sources 116. The hub application 104 and/or AI models 110 may leverage the external data 118, including credit scores and financial goals, to enhance the accuracy and relevance of recommendations. For example, such integrations may allow the AI models 110 and/or hub application 104 to conduct more robust pre-screening operations and pre-qualification processes for financial products.

By continuously analyzing user data, the hub application 104 and/or AI models 110 may identify opportunities to deepen client relationships through targeted offers and personalized communication.

The system 100 provides safeguards for ensuring the security of user data in the internal data 106 and/or aggregated data 108, such as encryption, data anonymization, etc. Doing so may provide compliance with regulatory requirements that are integrated into the system 100. The system 100 further implements robust security measures to protect user credentials and account information during transmission and storage.

The hub application 104 may include an enhanced planning dashboard with interactive widgets, pre-filled goal-setting options, personalized financial wellness articles, and top-rated planning insights to enrich the digital client experience. One example of a dashboard provided by the hub application 104 includes a net worth widget to provide users with a comprehensive view of their financial health, including assets and liabilities. As another example, a cash flow dashboard may be specifically designed for small businesses, promoting the use of tools with customizable settings.

In some embodiments, the hub application 104 may provide financial planning tools and insights, allowing users to create digital plans and engage with financial advisors. Similarly, the hub application 104 herein may provide proactive spending and budget tracking. For example, the hub application 104 may provide proactive spending and budget tracking features, including auto-saving and fee-saving insights for products.

In some embodiments, the hub application 104 may provide life journey guidance with specified goals, linking user needs with products and promoting active planning insights. Similarly, the hub application 104 may enable self-service management of online banking credentials used by third-party aggregators, ensuring user control and security. In some embodiments, onboarding enhancements are offered to drive engagement and provide personalized marketing offers based on user data.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 114 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 112 may include automatic teller machines (ATMs) utilized by the system 100 in serving users. In another example, the servers 102 represent payment clearinghouse or payment rail systems for processing payment transactions, and in another example, the servers 102 such as merchant systems or banking systems configured to interact with the user devices 112 during transactions and also configured to interact with the enterprise system 100 in back-end transactions clearing processes.

The user devices 112 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 112) to serve users in their interactions to communicate and take action. In such embodiments, the user devices 112 can be, as non-limiting examples, computing devices, kiosks, terminals, smart devices such as phones, and devices and tools at customer service counters and windows at POS locations.

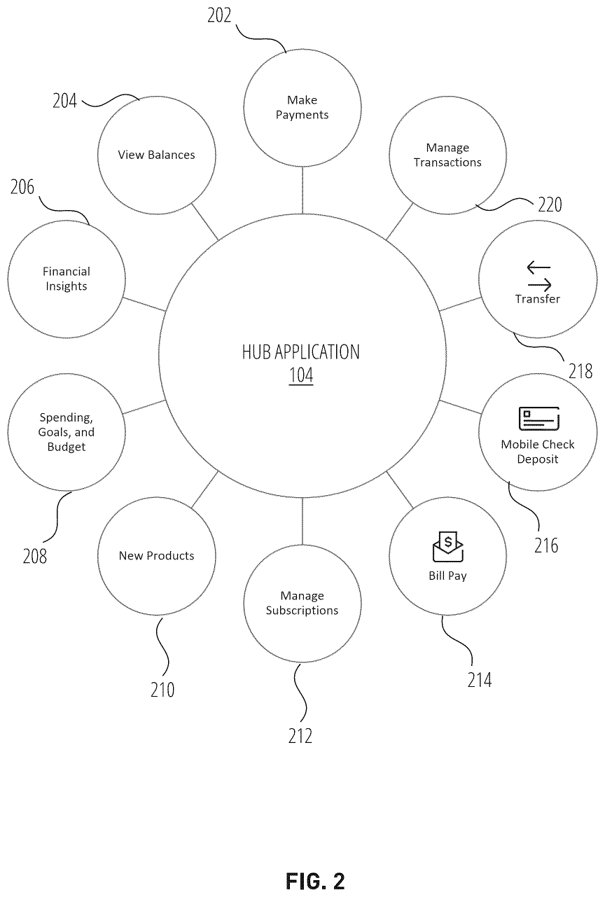

FIG. 2 illustrates components, or features, of the hub application 104, according to one embodiment. As shown, the hub application 104 may provide (or expose) a payment feature 202, a view balance feature 204, a financial insight feature 206, a planning feature 208, a new product feature 210, a subscription management feature 212, a bill pay feature 214, a mobile check deposit feature 216, a transfer feature 218, and a transaction management feature 220. Each feature may be implemented in one or more pages, or widgets, of the hub application 104.

In some embodiments, the hub application 104 provides a “Plan and Track” landing page that provides interactive widgets, pre-filled goal-setting options, personalized financial wellness articles, and top-rated planning insights. The widgets, goal-setting options, and/or planning insights may be based on the aggregated data 108. In some embodiments, the widgets, goal-setting options, and/or planning insights may be exposed via one or more of the payment feature 202, view balance feature 204, financial insight feature 206, planning feature 208, new product feature 210, subscription management feature 212, bill pay feature 214, mobile check deposit feature 216, transfer feature 218, and/or transaction management feature 220.

The payment feature 202 allows users to make payments directly from the hub application 104. For example, users can pay for goods and services, settle debts, or send money to friends and family with ease. The payment feature 202 supports various payment methods, including credit cards, debit cards, bank transfers, ACH, application-based transfers, digital currency transfers, etc. The payment feature 202 may be used to transfer funds between internal accounts, external accounts, or any combination thereof.

The view balance feature 204 provides real-time access to account balances across multiple financial institutions, e.g., based on the aggregated data 108. Using the view balance feature 204, users can quickly check their available funds, monitor their spending, and ensure they have sufficient balances to cover upcoming expenses. The view balance feature 204 may be used to view balances of internal accounts, external accounts, or any combination thereof.

The financial insight feature 206 leverages data analytics and artificial intelligence to provide users with valuable insights into their financial behavior. For example, the financial insight feature 206 may identify spending patterns, highlight areas where users can save money, and offer personalized financial advice to help users achieve their financial goals.

The planning feature 208 enables users to set and track financial goals, such as saving for a vacation, buying a home, or planning for retirement. Via the planning feature 208, users can create detailed financial plans, monitor their progress, and receive recommendations on how to stay on track. For example, using the planning feature 208, a client may create a monthly budget, annual budget, retirement plan, etc.

The new product feature 210 introduces users to new financial products and services that may be of interest to them. For example, new product feature 210 may recommend credit cards with better rewards, loan options with lower interest rates, or investment opportunities based on the user's financial profile and goals.

The subscription management feature 212 helps users create and manage their subscriptions and recurring payments, e.g., with the data sources 116. Via the subscription management feature 212, users can view all their active subscriptions in one place, track their costs, and receive alerts for upcoming renewals or price changes. The subscription management feature 212 also allows users to cancel unwanted subscriptions easily.

The bill pay feature 214 simplifies the process of paying bills or other amounts owed to one or more recipients. Via the bill pay feature 214, users may schedule one-time or recurring bill payments, set up reminders for due dates, and ensure that their bills are paid on time. The bill pay feature 214 supports payments to various billers, including utilities, credit cards, and service providers.

The mobile check deposit feature 216 allows users to deposit checks using their mobile devices. Users can take a photo of the check, enter the deposit amount, and submit the deposit through the hub application 104. This eliminates the need to visit a bank branch or ATM to deposit checks.

The transfer feature 218 enables users to transfer funds between their accounts at different financial institutions. Users can initiate transfers with a few clicks, whether they are moving money between checking and savings accounts or sending funds to external accounts. For example, the transfer feature 218 may allow the user to transfer funds between accounts in the internal data 106 (e.g., within a single financial institution), between accounts in the aggregated data 108 (e.g., with external financial institutions), and/or between accounts in the internal data 106 and accounts in the aggregated data 108 (e.g., between accounts held at two or more financial institutions).

The transaction management feature 220 provides users with tools to manage and categorize their transactions. Using the transaction management feature 220, users can view their transaction history, categorize expenses, and generate reports to better understand their spending habits. The transaction management feature 220 supports transaction search and filtering for easy access to specific transactions.

The hub application 104 may further include any other type of features not depicted in FIG. 2. Examples include a net worth feature to display a client's net worth, a cash flow dashboard tailored for small businesses, etc. The cash flow dashboard for small businesses may include promotions to link external accounts before enrollment using customized settings.

Similarly, the hub application 104 includes features to link external accounts, unlink external accounts, and/or modify linked external accounts. Furthermore, the hub application 104 refreshes aggregated accounts in real-time while providing detailed indications of any errors. The hub application 104 may provide consistent aggregated account list and detail across digital channels, account types and client segments. Similarly, the hub application 104 may provide self-service management of access credentials. In some embodiments, the hub application 104 drives engagement for the hub application 104 and credit scores to become more consultative for clients while leveraging data to provide personalized marketing offers. Similarly, the hub application 104 may increase engagement by educating on new features and capabilities to drive digital adoption for the features of the hub application 104. The hub application 104 may further aggregate account flows with reduced requested credential frequency while supporting manual account linkage for any external account.

The AI models 110 may be used in conjunction with any of the features of the hub application 104. For example, AI models 110 may encourage clients to better manage holistic finances while leveraging the aggregated data 108 to enable personalized marketing offers. Similarly, the AI models 110 may enable an enhanced planning feature 208 for retail, premier, and wealth clients to promote the hub application 104 before enrollment with customizable settings. Similarly, the AI models 110 and/or the hub application 104 may enrich the aggregated data 108 for transactions received from the external data 118 (e.g., third party transactions) and display these enriched details via the transaction management feature 220.

In some embodiments, one or more features may be linked in operation. For example, the AI models 110 may determine, based on the aggregated data 108, the client has an upcoming bill payment, but insufficient funds in an internal account. Therefore, the AI models 110 may generate a suggestion to use the transfer feature 218 to transfer funds from an external account to an internal account and use the transferred funds to pay the bill using the bill pay feature 214. If the user approves the recommendation, the AI models 110 and/or the hub application 104 may automate the process of transferring funds from the external account to the internal account and use the transferred funds to pay the bill using the bill pay feature 214. Embodiments are not limited in these contexts.

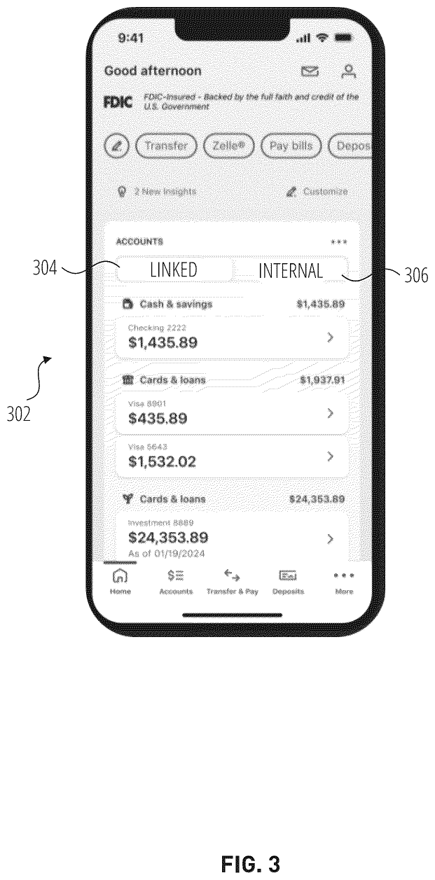

FIG. 3 illustrates a graphical user interface 302 provided by a page of the hub application 104, according to one embodiment. As shown, the graphical user interface 302 includes a linked account tab 304 and an internal accounts tab 306. The internal accounts tab 306 may display information related to one or more internal accounts associated with a financial institution that provides the hub application 104. The linked account tab 304 may display information related to one or more external accounts, e.g., accounts with other financial institutions. Stated differently, the linked account tab 304 may display information related to accounts that are linked from the external data 118 of the data sources 116. As shown, the graphical user interface 302 displays information related to a checking account, credit cards, and investment accounts. In some embodiments, the internal and external accounts are displayed in a single user interface. For example, in some embodiments, the graphical user interface 302 may display the accounts in the linked account tab 304 and accounts from the internal accounts tab 306. Embodiments are not limited in these contexts.

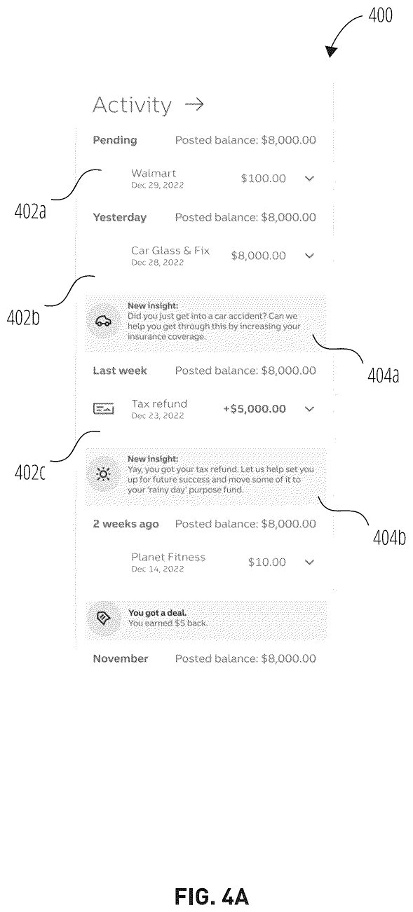

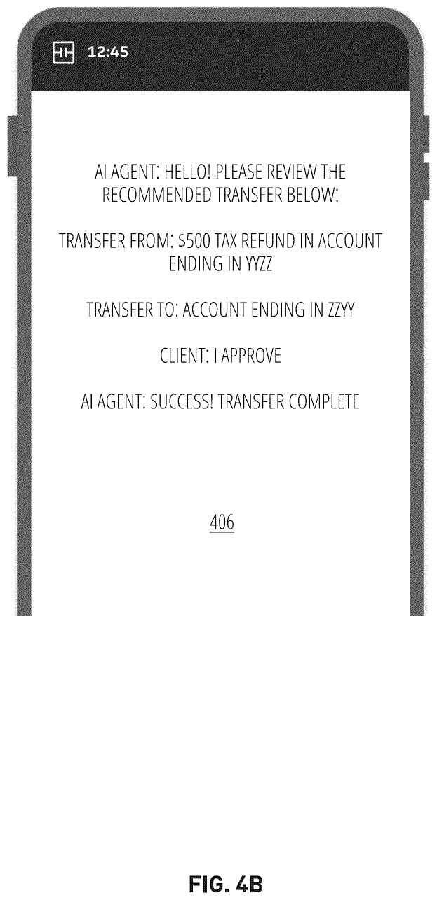

FIG. 4A illustrates a graphical user interface 400 provided by a page of the hub application 104, according to one embodiment. As shown, the graphical user interface 400 includes account activity for a plurality of accounts. For example, the graphical user interface 400 a transaction entry 402a, a transaction entry 402b, and a transaction entry 402c. The transaction entries 402a-402c display information related to a respective transaction. Data associated with or more of the transactions associated with transaction entries 402a-402c may be received by the hub application 104 from the external data 118 of the data sources 116. For example, transaction entry 402a may be received from transaction logs in the internal data 106 of a first financial institution (e.g., an institution providing the hub application 104), transaction entry 402b may be received from transaction logs in the external data 118 of a second financial institution, and transaction entry 402c may be received from transaction logs in the external data 118 of a third financial institution. Doing so provides a holistic view of the account holder's finances.

Furthermore, as stated, one or more AI models 110 may analyze the data of a user and generate one or more recommendations. In the example depicted in FIG. 4A, the AI model 110 may create a recommendation 404a and a recommendation 404b. As shown, the recommendation 404a recommends increasing insurance coverage. The recommendation 404a may generate the recommendation 404a based on analyzing the internal data 106 and/or the external data 118 in the aggregated data 108. For example, the aggregated data 108 may include data reflecting the user was in a car accident (e.g., incident reports, medical bills, insurance records, etc.). The AI model 110 may therefore generate the recommendation 404a based on the data.

Similarly, the recommendation 404b is based on data in the aggregated data 108 that reflects the user received a tax refund. For example, a transaction record in the internal data 106 and/or external data 118 in the aggregated data 108 may reflect an income tax refund payment. As such, the AI model 110 may identify the income tax refund and generate the recommendation 404b. The recommendation 404b may be associated with one of the features of the hub application 104. For example, the AI model 110 may associate the recommendation 404b with the transfer feature 218 of the hub application 104. Doing so may cause the recommendation 404b to launch and pre-populate the transfer feature 218 with information, e.g., to transfer at least a portion of the tax refund to a savings account. Embodiments are not limited in these contexts.

FIG. 4B depicts a graphical user interface 406 provided by a page of the hub application 104, according to one embodiment. The graphical user interface 406 may be generated by the hub application 104 based on selection of the recommendation 404b of FIG. 4A. As stated, the AI model 110 may associate the recommendation 404b with the transfer feature 218 of the hub application 104. Therefore, the graphical user interface 406 reflects an example of the transfer feature 218 that is enhanced with an AI model 110 as a chatbot.

As shown, the AI model 110 recommends transferring $500 of the tax refund to a predetermined account. The account may be selected from the aggregated data 108 of the client. The account may be an internal account, e.g., one of the accounts in the internal data 106. Based on the client's approval message, the hub application 104 may automatically initiate the transfer of the funds from one account to the other account. The funds may then be transferred per the recommendation 404b. Embodiments are not limited in these contexts.

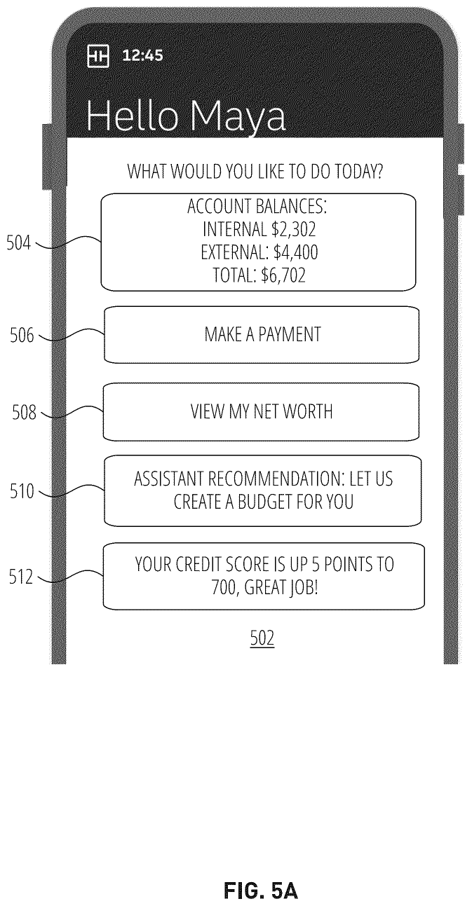

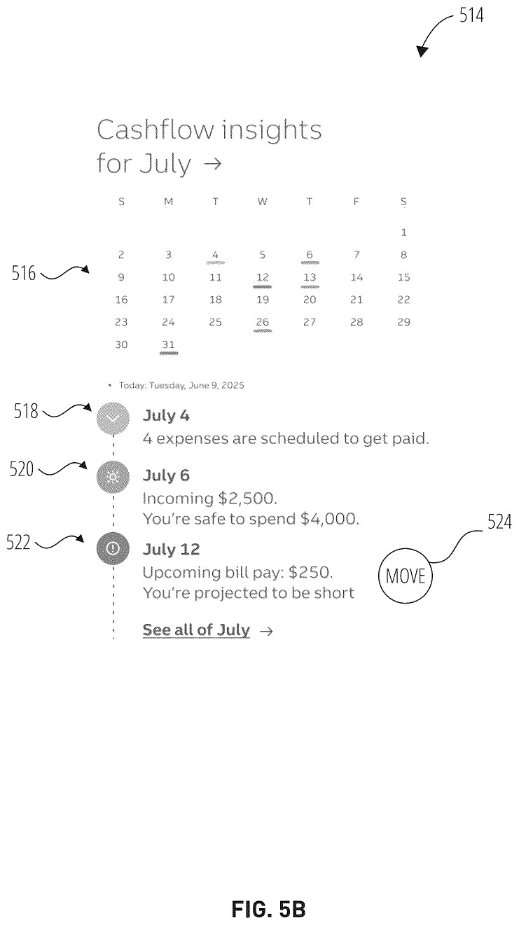

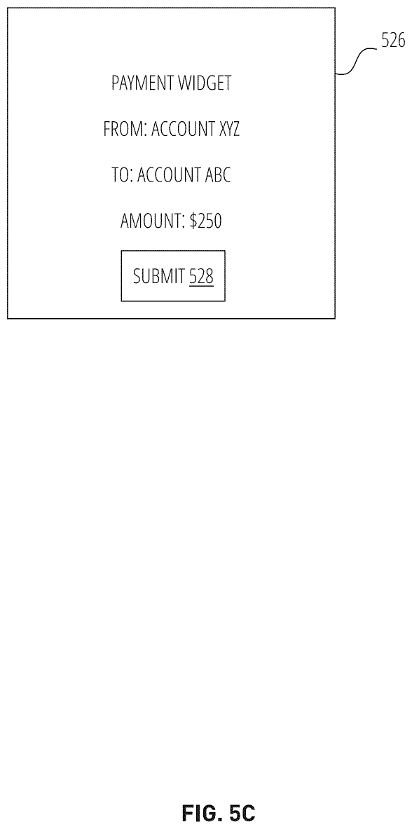

FIG. 5A illustrates a graphical user interface 502 provided by a page of the hub application 104, according to one embodiment. As shown, the graphical user interface 502 includes indications of a subset of a plurality of features provided by the hub application 104. For example, as shown, the graphical user interface 502 includes a balance feature widget 504, a payment feature widget 506, a net worth widget 508, a recommendation 510, and a credit score widget 512.

The balance feature widget 504, when selected, may provide the view balance features 204 of the hub application 104, e.g., to display a detailed, consolidated view of the internal and external accounts of the client, such as the graphical user interface 302 of FIG. 3. The payment feature widget 506, when selected, may provide the payment feature 202 of the hub application 104, e.g., to allow the user to initiate a payment to a recipient using a payment source, e.g., one of the accounts of the client in the aggregated data 108. The net worth widget 508, when selected, may provide a net worth feature of the hub application 104, e.g., to display the net worth of the client. The net worth may be determined based on the assets and liabilities of the client as determined based on the aggregated data 108 of the client. The credit score widget 512, when selected, may provide detailed information related to the credit score and/or credit history of the client in the hub application 104.

The recommendation 510 is a recommendation generated by an AI model 110. The recommendation 510 may be based on the aggregated data 108 for the client and the features of the hub application 104. Generally, the AI model 110 may determine the client has trouble maintaining a positive account balance across all accounts in the aggregated data 108, e.g., based on incoming funds being less than outgoing funds. As such, the AI model 110 may generate the recommendation to use the planning feature 208, where the planning feature 208 may generate a budget for the client automatically.

FIG. 5B illustrates a graphical user interface 514 provided by a page of the hub application 104, according to one embodiment. The graphical user interface 514 may be generated based on the selection of the recommendation 510 of FIG. 5A. The graphical user interface 514 may be generated based on the data of the client, e.g., data in the aggregated data 108. For example, the hub application 104 may generate a calendar 516 to inform the client of various events (e.g., dates payments are due and/or expected to be received, etc.). The calendar 516 may underline various dates to indicate corresponding events.

Similarly, the graphical user interface 514 includes notification 518, notification 520, and notification 522. The hub application 104 and/or AI models 110 may generate the notification 518, notification 520, and notification 522 based on the client's data in the aggregated data 108. For example, by identifying due dates of bills in the aggregated data 108 (and/or the due dates of prior recurring bills in the aggregated data 108), the hub application 104 and/or AI models 110 may generate notification 518 to inform the client of the bills due on July 4.

Similarly, by identifying pay dates (e.g., from payroll data, prior payments by the client's employer in the aggregated data 108, etc.), the hub application 104 and/or AI models 110 may generate the notification 520 to inform the client of the upcoming pay date. Furthermore, as shown, notification 520 further includes an indication of a budget, or spending limit for the customer, for the month. In the example of FIG. 5B, the notification 520 indicates the customer can spend $4,000 without going over budget for the month. For example, by identifying, in the aggregated data 108, upcoming payments due and payments to be received by the client, the hub application 104 and/or AI models 110 may determine that the client has $4,000 available to spend.

As another example, notification 522 reflects a bill payment of $250 is due, e.g., based on identifying recurring past payments in the aggregated data 108 and/or by identifying the bill in the aggregated data 108. Furthermore, the notification 522 indicates that the customer is projected to be short, e.g., will not have the funds available to pay the bill on the due date. However, based on the projected shortfall, the AI model 110 may generate a recommendation 524. The recommendation 524, when selected, may lead the client to the transfer feature 218.

FIG. 5C illustrates a graphical user interface 526 provided by a page of the hub application 104, according to one embodiment. The graphical user interface 526 may be generated based on selection of recommendation 524 of FIG. 5B. As shown, the graphical user interface 526 reflects the payment feature 202 of the hub application 104, which is pre-populated with information to complete a transfer to avoid the projected budget shortfall. As shown, the source account, target account, and transfer amount are pre-populated in the graphical user interface 526. Based on selection of the selectable element 528, the client may approve the transfer of funds, thereby ensuring the client has sufficient funds in the account to pay for the bill associated with notification 522. Embodiments are not limited in these contexts.

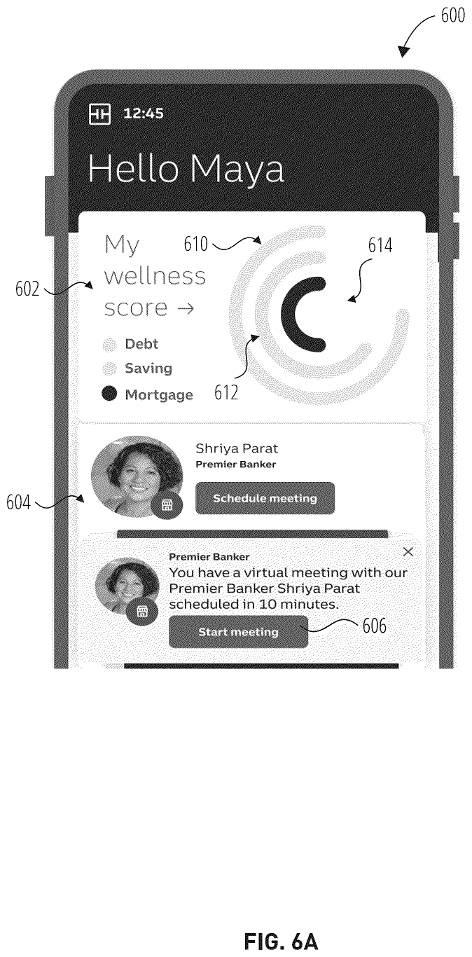

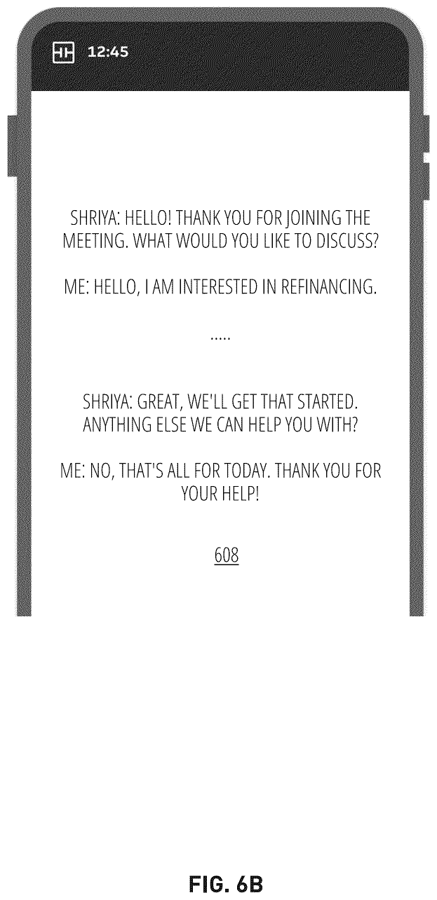

FIG. 6A illustrates an example graphical user interface 600 provided by a page of the hub application 104, according to one embodiment. As shown, the graphical user interface 600 includes a wellness interface 602 which reflects a financial health of the client based on the aggregated data 108 of the client. As shown, the wellness interface 602 includes a debt component 610, a savings component 612, and a mortgage component 614. The debt component 610 may be based on an aggregated debt of the client, e.g., which may be determined based on the aggregated data 108. The savings component 612 may be based on an aggregated savings of the client, which may be determined based on the aggregated data 108. The mortgage component 614 may be based on a balance of one or more mortgages of the client, e.g., which may be determined based on the aggregated data 108. In some embodiments, wellness interface 602 may include a numeric score generated based on the debt component 610, savings component 612, and/or mortgage component 614.

As shown, the graphical user interface 600 includes a chat scheduler 604, which allows the user to schedule an online meeting with an employee of the financial institution. Once scheduled, the user may enter the chat using selectable element 606.

FIG. 6B illustrates a chat interface 608 provided by a page of the hub application 104, according to one embodiment. The chat interface 608 may be loaded in the hub application 104 when the user selects selectable element 606 of FIG. 6A. As shown, the user may converse with the employee of the financial institution via the chat interface 608. In some embodiments, the user may converse using speech input via a microphone of user device 112. The speech signals may be processed, e.g., using speech-to-text algorithms to create the text depicted in chat interface 608 Embodiments are not limited in these contexts.

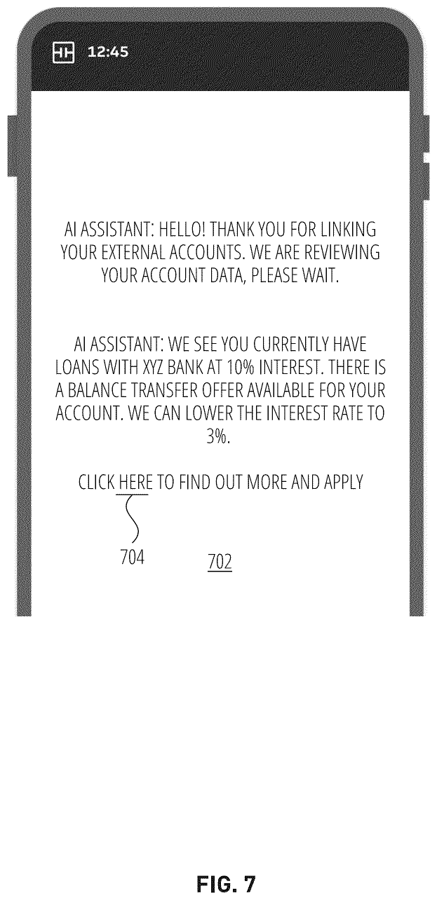

FIG. 7 illustrates a graphical user interface 702 provided by a page of the hub application 104, according to one embodiment. As shown, the graphical user interface 702 allows the user to conduct a chat with an AI-based chatbot, e.g., one of the AI models 110. As depicted in the graphical user interface 702, the user completed providing authentication credentials for linking external accounts. Once the accounts are linked, the external data 118 may be received from the data sources 116 and stored in the aggregated data 108. The AI model 110 may analyze the data in the aggregated data 108 to generate a recommendation. For example, as shown, the AI model 110 identified a loan with particular features in the external data 118. The AI model 110 therefore generates a recommendation for a loan with lower interest rates. The user may use link 704 to learn more about the loan and/or apply for the loan. Although not depicted, in some embodiments, the AI model 110 may generate another recommendation, e.g., for an employee of the financial institution, based on the recommendation outputted in FIG. 7. For example, the AI model 110 may send a notification to an employee who helps customers apply for loans, where the notification indicates the possibility for the user to lower their interest rate. Doing so may allow the employee to reach out to the customer. Embodiments are not limited in these contexts.

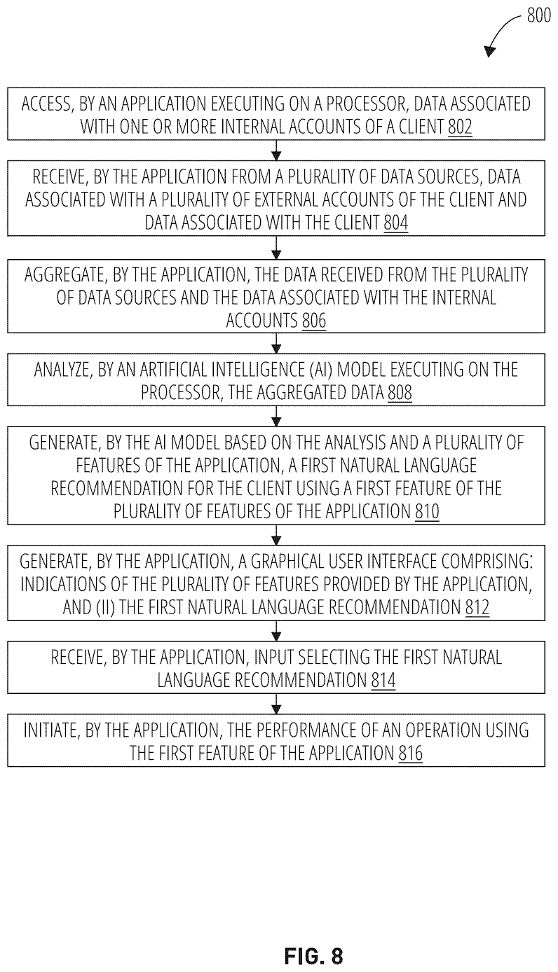

FIG. 8 illustrates an example logic flow 800. Although the example logic flow 800 depicts a particular sequence of operations, the sequence may be altered without departing from the scope of the present disclosure. For example, some of the operations depicted may be performed in parallel or in a different sequence that does not materially affect the function of the logic flow 800. In other examples, different components of an example device or system that implements the logic flow 800 may perform functions at substantially the same time or in a specific sequence.

According to some examples, the logic flow 800 includes accessing, by an application executing on a processor, data associated with one or more internal accounts of a client at block 802. For example, the hub application 104 illustrated in FIG. 1 may access data associated with one or more internal accounts of a client, e.g., one or more accounts in the internal data 106.

According to some examples, the logic flow 800 includes receiving, by the application from a plurality of data sources, data associated with a plurality of external accounts of the client and data associated with the client at block 804. For example, the hub application 104 illustrated in FIG. 1 may receive, from a plurality of data sources 116, data associated with a plurality of external accounts of the client and data associated with the client.

According to some examples, the logic flow 800 includes aggregating, by the application, the data received from the plurality of data sources and the data associated with the one or more internal accounts at block 806. For example, the hub application 104 illustrated in FIG. 1 may aggregate the data received from the plurality of data sources 116 with the data from the internal data 106, thereby creating the aggregated data 108.

According to some examples, the logic flow 800 includes analyzing, by an artificial intelligence (AI) model executing on the processor, the aggregated data at block 808. For example, the AI model 110 illustrated in FIG. 1 may analyze the aggregated data.

According to some examples, the logic flow 800 includes generating, by the AI model based on the analysis and a plurality of features of the application, a first natural language recommendation for the client using a first feature of the plurality of features of the application at block 810. For example, the AI model 110 illustrated in FIG. 1 may generate, based on the analysis and a plurality of features of the application, a first natural language recommendation for the client using a first feature of the plurality of features of the application. For example, the first feature may be the bill pay feature 214 and the first natural language recommendation may specify to process a payment using the bill pay feature 214.

According to some examples, the logic flow 800 includes generating, by the application, a graphical user interface comprising: indications of the plurality of features provided by the application, and (ii) the first natural language recommendation at block 812. For example, the hub application 104 illustrated in FIG. 1 may generate a graphical user interface comprising: indications of the plurality of features provided by the application, and (ii) the first natural language recommendation.

According to some examples, the logic flow 800 includes receiving, by the application, input selecting the first natural language recommendation at block 814. For example, the hub application 104 illustrated in FIG. 1 may receive input selecting the first natural language recommendation, e.g., to complete the bill payment using the bill pay feature 214.

According to some examples, the logic flow 800 includes initiating, by the application, the performance of an operation using the first feature of the application at block 816. For example, the hub application 104 illustrated in FIG. 1 may initiate the performance of the bill payment using the bill pay feature 214 of the application. In some embodiments, the hub application 104 and/or AI model 110 may pre-populate information in a page associated with the bill pay feature 214, e.g., the amount, recipient, funding source, etc. Doing so may allow the user to automatically submit the payment.

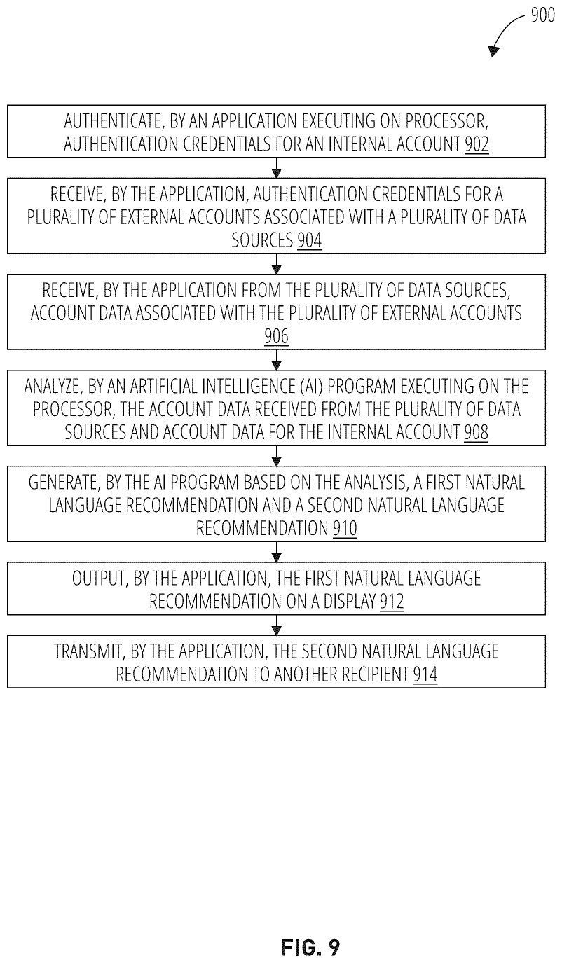

FIG. 9 illustrates an example logic flow 900. Although the example logic flow 900 depicts a particular sequence of operations, the sequence may be altered without departing from the scope of the present disclosure. For example, some of the operations depicted may be performed in parallel or in a different sequence that does not materially affect the function of the logic flow 900. In other examples, different components of an example device or system that implements the logic flow 900 may perform functions at substantially the same time or in a specific sequence.

According to some examples, the logic flow 900 includes authenticating, by an application executing on processor, authentication credentials for an internal account at block 902. For example, the hub application 104 illustrated in FIG. 1 may authenticate authentication credentials for an internal account such as an account in the internal data 106. The authentication credentials may be received from a user having one or more accounts in the internal data 106 and one or more accounts in the external data 118.

According to some examples, the logic flow 900 includes receiving, by the application, authentication credentials for a plurality of external accounts associated with a plurality of data sources at block 904. For example, the hub application 104 illustrated in FIG. 1 may receive authentication credentials for a plurality of external accounts stored in the external data 118. The external accounts may be associated with a plurality of data sources 116. The external accounts may include accounts with financial institutions, credit bureaus, merchants, etc.

According to some examples, the logic flow 900 includes receiving, by the application from the plurality of data sources, account data associated with the plurality of external accounts at block 906. For example, the hub application 104 illustrated in FIG. 1 may receive, from the external data 118 of the plurality of data sources 116, account data associated with the plurality of external accounts.

According to some examples, the logic flow 900 includes analyzing, by an AI model executing on the processor, the account data received from the plurality of data sources and account data for the internal account at block 908. For example, the AI model 110 illustrated in FIG. 1 may analyze, the aggregated data 108 (e.g., the account data received from the plurality of data sources and account data for the internal account).

According to some examples, the logic flow 900 includes generating, by the AI model based on the analysis, a first natural language recommendation and a second natural language recommendation at block 910. For example, the AI model 110 illustrated in FIG. 1 may generate, based on the analysis, a first natural language recommendation and a second natural language recommendation. The first natural language recommendation may be tailored for the user and the second natural language recommendation may be for tailored an employee of the financial institution.

According to some examples, the logic flow 900 includes outputting, by the application, the first natural language recommendation on a display at block 912. For example, the hub application 104 illustrated in FIG. 1 may output the first natural language recommendation on a display, e.g., on the user device 112 of the user.

According to some examples, the logic flow 900 includes transmitting, by the application, the second natural language recommendation to another recipient at block 914. For example, the hub application 104 illustrated in FIG. 1 may transmit the second natural language recommendation to another recipient, e.g., to the user device 112 of the employee of the financial institution.

As used herein, an artificial intelligence system, artificial intelligence algorithm, artificial intelligence module, program, and the like, generally refer to computer implemented programs that are suitable to simulate intelligent behavior (e.g., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

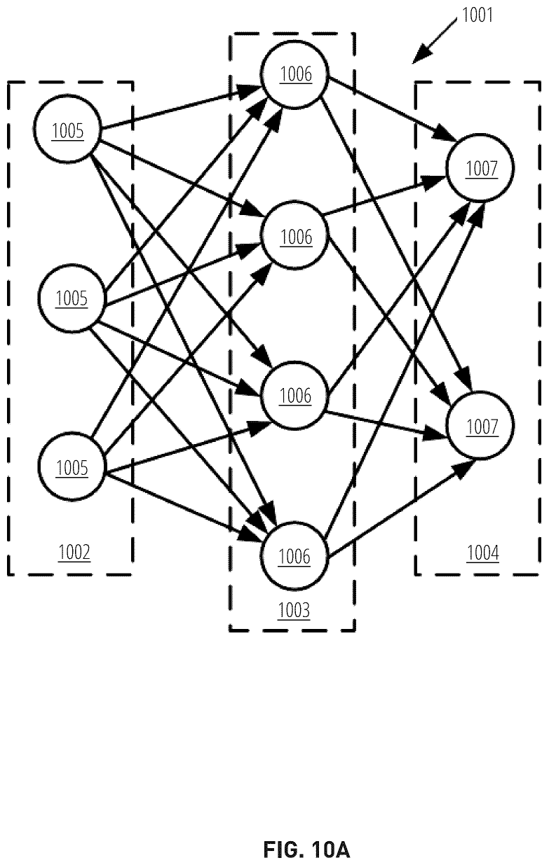

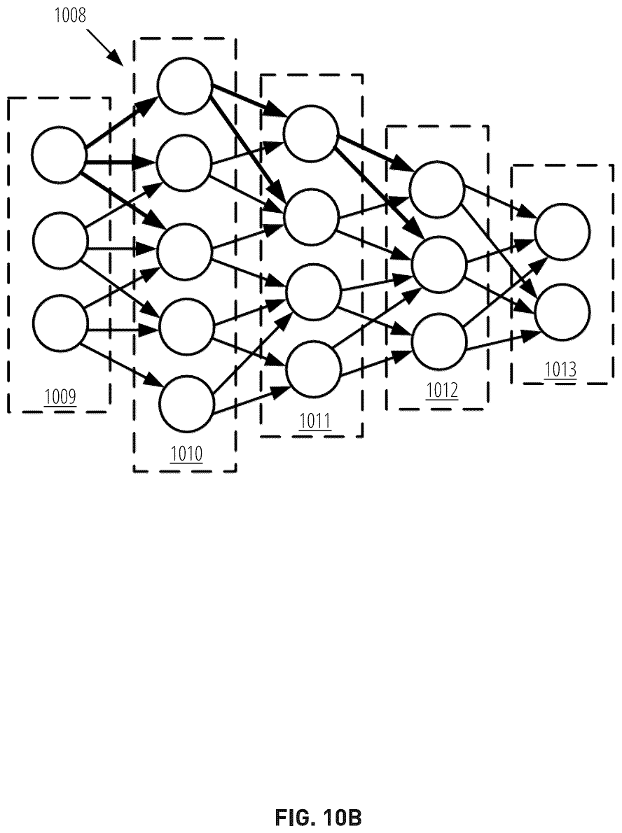

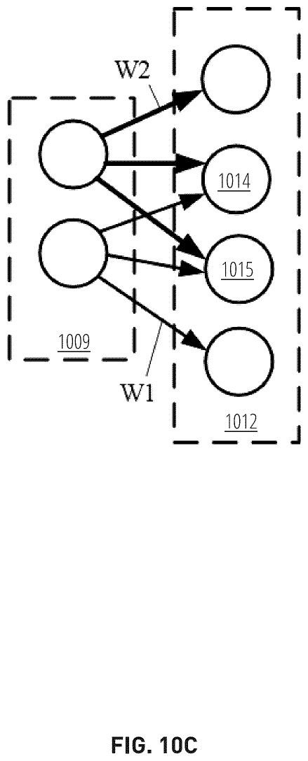

An artificial neural network (ANN), also known as a feedforward network, may be utilized, e.g., an acyclic graph with nodes arranged in layers. A feedforward network (see, e.g., feedforward network 1001 referenced in FIG. 10A) may include a topography with a hidden layer 1003 between an input layer 1002 and an output layer 1004. The input layer 1002, having nodes commonly referenced in FIG. 10A as input nodes 1005 for convenience, communicates input data, variables, matrices, or the like to the hidden layer 1003, having nodes 1006. The hidden layer 1003 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 1005 of the input layer, which then communicates the data to the hidden layer 1003. The hidden layer 1003 may be configured to determine the state of the nodes in the respective layers and assign weight coefficients or parameters of the nodes based on the edges separating each of the layers, e.g., an activation function implemented between the input data communicated from the input layer 1002 and the output data communicated to the nodes 1007 of the output layer 1004. It should be appreciated that the form of the output from the neural network may generally depend on the type of model represented by the algorithm. Although the feedforward network 1001 of FIG. 10A expressly includes a single hidden layer 1003, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 1008 in FIG. 10B. As in the feedforward network 1001 of FIG. 10A, the illustrated example of FIG. 10B has an input layer 1009 and an output layer 1013. However where a single hidden layer 1003 is represented in FIG. 10A, multiple consecutive hidden layers 1010, 1011, and 1012 are represented in FIG. 10B. The edge neurons represented by white-filled arrows highlight that hidden layer nodes can be connected locally, such that not all nodes of succeeding layers are connected by neurons.

FIG. 10C, representing a portion of the convolutional neural network 1008 of FIG. 10B, specifically portions of the input layer 1009 and the first hidden layer 1010, illustrates that connections can be weighted. In the illustrated example, labels W1 and W2 refer to respective assigned weights for the referenced connections. Two hidden nodes 1014 and 1015 share the same set of weights W1 and W2 when connecting to two local patches.

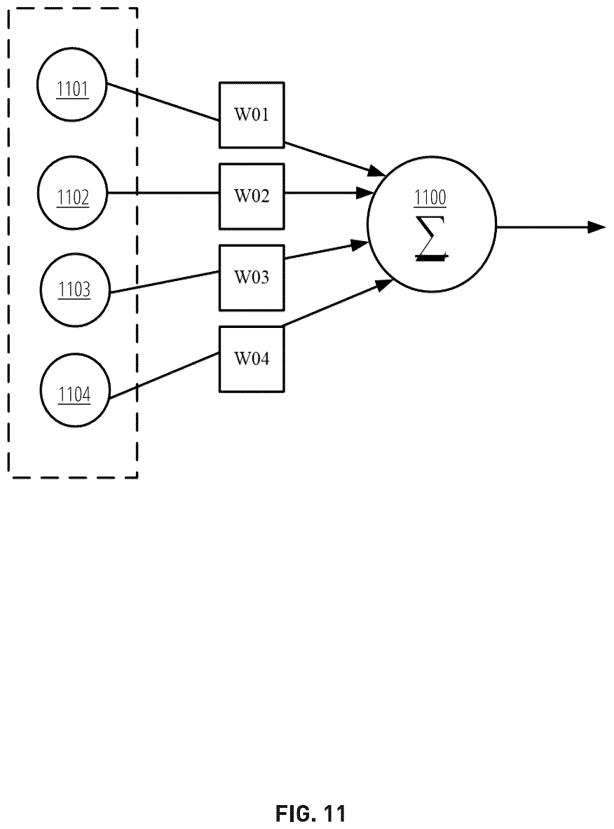

Weight defines the impact a node in any given layer has on computations by a connected node in the next layer. FIG. 11 represents a particular node 1100 in a hidden layer. The node 1100 is connected to several nodes in the previous layer representing inputs to the node 1100. The input nodes 1101, 1102, 1103 and 1104 are each assigned a respective weight W01, W02, W03, and W04 in the computation at the node 1100, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current computation of the parameter, e.g., at least a portion of the output data from the RNN may be used as feedback/input in computing subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

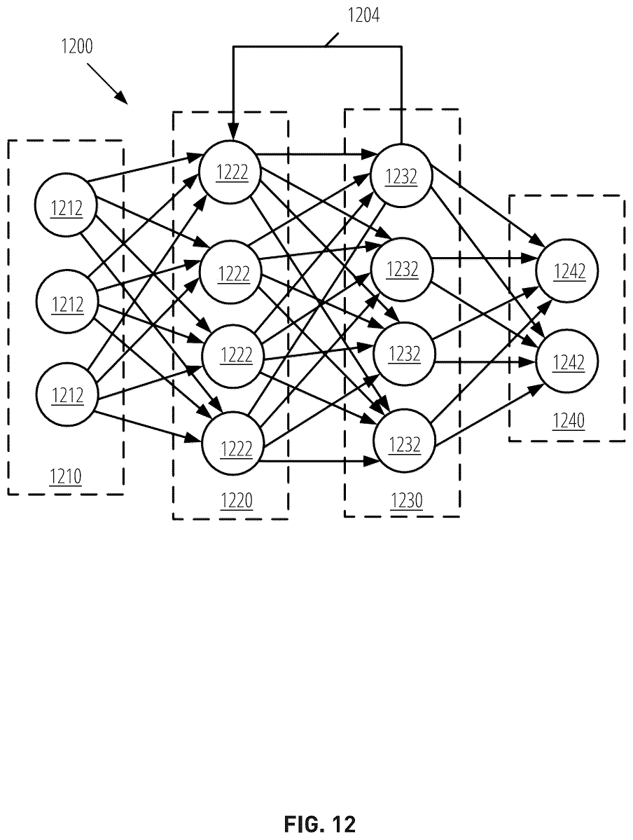

An example for a Recurrent Neural Network (RNN) is referenced as 1200 in FIG. 12. As in the feedforward network 1001 of FIG. 10A, the illustrated example of FIG. 12 has an input layer 1210 (with nodes 1212) and an output layer 1240 (with nodes 1242). However, where a single hidden layer 1003 is represented in FIG. 10A, multiple consecutive hidden layers 1220 and 1230 are represented in FIG. 12 (with nodes 1222 and nodes 1232, respectively). As shown, the RNN 1200 includes a feedback connector 1204 configured to communicate parameter data from at least one node 1232 from the second hidden layer 1230 to at least one node 1222 of the first hidden layer 1220. It should be appreciated that two or more and up to all of the nodes of a subsequent layer may provide or communicate a parameter or other data to a previous layer of the RNN 1200. Moreover and in some embodiments, the RNN 1200 may include multiple feedback connectors 1204 (e.g., connectors 1204 suitable to communicatively couple pairs of nodes and/or feedback connectors 1204 configured to provide communication between three or more nodes). Additionally or alternatively, the feedback connector 1204 may communicatively couple two or more nodes having at least one hidden layer between them, e.g., nodes of nonsequential layers of the RNN 1200. In some embodiments, the AI models 110 may include an ANN such as feedforward network 1001, a CNN 1008, and/or an RNN such as recurrent neural network 1200.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

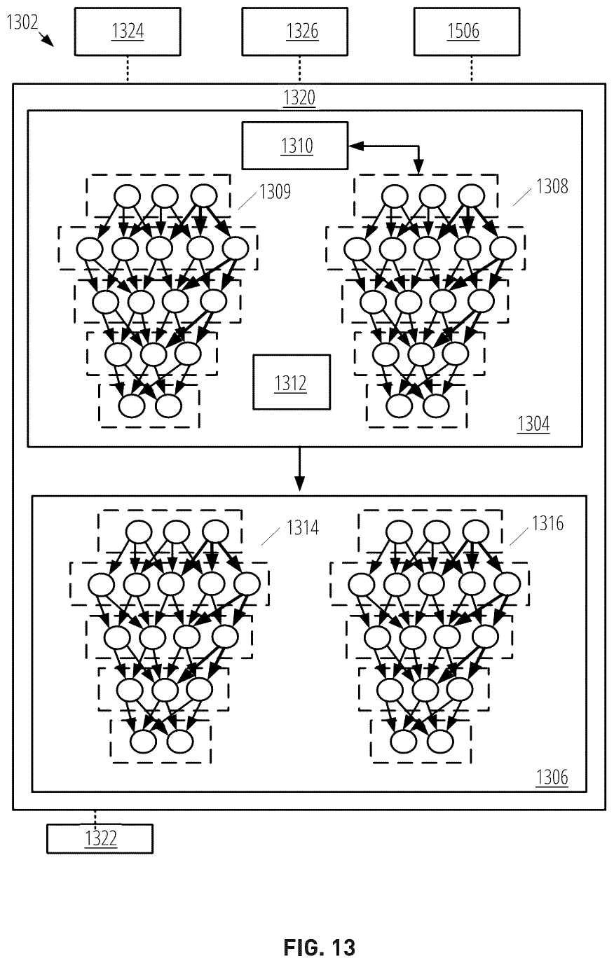

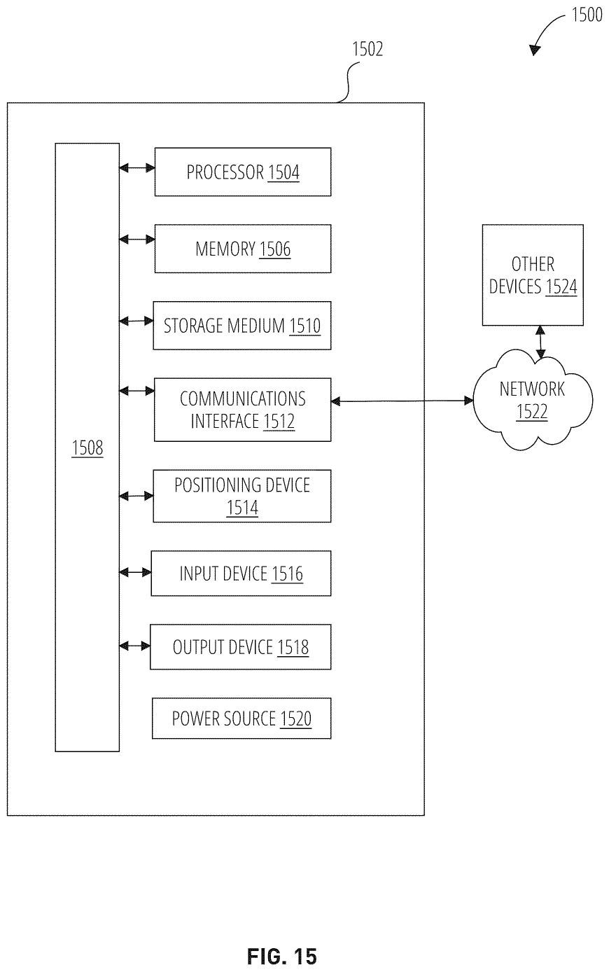

Referring now to FIG. 13 and some embodiments, an artificial intelligence (AI) program 1302 may include a front-end algorithm 1304 and a back-end algorithm 1306. The artificial intelligence program 1302 may be implemented on an AI processor 1320, such as the processor 1504 of computer 1502 of FIG. 15, and/or a dedicated processing device (e.g., servers 102 and/or user devices 112). Therefore, the artificial intelligence program 1302 is an example of the AI models 110. The instructions associated with the front-end algorithm 1304 and the back-end algorithm 1306 may be stored in an associated memory device and/or storage device of the system (e.g., memory 1324 and/or storage 1326 in FIG. 13), etc.) communicatively coupled to the AI processor 1320, as shown. Additionally or alternatively, one or more memory devices and/or storage devices (e.g., storage medium 1510 and/or memory 1506 of FIG. 15, etc.) may be used for processing use and/or including one or more instructions necessary for operation of the AI program 1302. In some embodiments, the AI program 1302 may include a deep neural network (e.g., a front-end algorithm 1304 configured to perform pre-processing, such as feature recognition, and a back-end algorithm 1306 configured to perform an operation on the data set communicated directly or indirectly to the back-end algorithm 1306). For instance, the front-end algorithm 1304 can include at least one CNN 1308 communicatively coupled to send output data to the back-end algorithm 1306.

Additionally or alternatively, the front-end algorithm 1304 can include one or more AI algorithms 1310, 1312 (e.g., statistical models or machine learning programs such as decision tree learning, associate rule learning, recurrent artificial neural networks, support vector machines, and the like). In various embodiments, the front-end algorithm 1304 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 1308 and/or AI algorithm 1310 may be used for image recognition, input categorization, and/or support vector training. In some embodiments and within the front-end algorithm 1304, an output from an AI algorithm 1310 may be communicated to a CNN 1308 or 1309, which processes the data before communicating an output from the CNN 1308, 1309 and/or the front-end algorithm 1304 to the back-end algorithm 1306. In various embodiments, the back-end algorithm 1306 may be configured to implement input and/or model classification, speech recognition, translation, and the like. For instance, the back-end algorithm 1306 may include one or more CNNs (e.g., CNN 1314) or dense networks (e.g., dense networks 1316), as described herein.

For instance, and in some embodiments of the AI program 1302, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end algorithm 1304). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 1302 may be trained using a semi-supervised learning process in which some but not all of the output data is known, e.g., a mix of labeled and unlabeled data having the same distribution.

In some embodiments, the AI program 1302 may be accelerated via a machine learning framework 1322 (e.g., hardware). The machine learning framework may include an index of operations, subroutines, and the like (primitives) typically implemented by AI and/or machine learning algorithms. Thus, the AI program 1302 may be configured to utilize the primitives of the framework 1322 to perform some or all of the computations required by the AI program 1302. Primitives suitable for inclusion in the machine learning framework 1322 include operations associated with training a convolutional neural network (e.g., pools), tensor convolutions, activation functions, algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naïve-Bayes, Random Forest (RF), matrix factorization, and support vector machines) in addition to, or as an alternative to, one or more neural networks, as described herein.

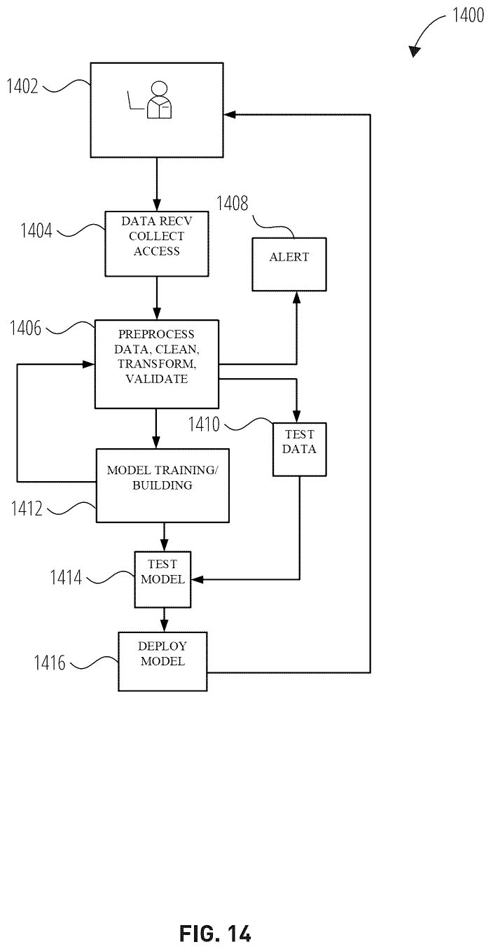

FIG. 14 is a flow chart representing a logic flow 1400, according to at least one embodiment, of model development and deployment by machine learning. The logic flow 1400 represents at least one example of a machine learning workflow in which operations are implemented in a machine-learning project, such as for the AI models 110.

In block 1402, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 1402 can represent a starting point. However, with regard to continuing or improving an ongoing machine learning workflow, block 1402 can represent an opportunity for further user input or oversight via a feedback loop. Such feedback may flow through a user, or in various embodiments, the method automatically provides feedback, retrains and redeploys the retrained model.

In block 1404, data is received, collected, accessed, or otherwise acquired and entered as can be termed data ingestion. For example, the data may include the internal data 106 and/or external data 118 in the aggregated data 108. In block 1406, the data ingested in block 1404 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 1406 is updated with newly ingested data, an updated model will be generated. Block 1406 can include data validation, which focuses on confirming that the statistics of the ingested data are as expected, such as that data values are within expected numerical ranges, that data sets are within any expected or required categories, and that data comply with any needed distributions such as within those categories. Block 1406 can proceed to block 1408 to automatically alert the initiating user, other human or virtual agents, and/or other systems, if any anomalies are detected in the data, thereby pausing or terminating the process flow until corrective action is taken.

In block 1410, training test data such as a target variable value is inserted into an iterative training and testing loop. In block 1412, model training, a core step of the machine learning workflow, is implemented. A model architecture is trained in the iterative training and testing loop. For example, features in the training test data are used to train the model based on weights and iterative computations in which the target variable may be incorrectly predicted in an early iteration as determined by comparison in block 1414, where the model is tested. Subsequent iterations of the model training, in block 1412, may be conducted with updated weights in the computations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (e.g., the model is underfitted), the system may automatically determine that the threshold level of accuracy is not satisfied and may adjust the weights for a subsequent iteration of the training and testing loop. The weights may be iteratively adjusted during each iteration of the training and testing loop based on the comparison to the threshold level of accuracy. However, there is a balance for training the model to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained. In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using computed derivatives to minimize a loss function. Backpropagation may be used to compute the gradient of the error function with respect to the neural network's weights.

When compliance and/or success in the model testing in block 1414 is achieved, process flow proceeds to block 1416, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see block 1416) and the feedback loop automatically provides feedback for further training of the machine learning model to improve its performance, and upon completion of the other method blocks such as block 1412, the machine learning model that has been automatically retrained based on the feedback loop is then redeployed (block 1414). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions for detecting anomalies to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

The systems and methods disclosed herein may also be used to analyze text to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply robotic process automation for digital transformation of the data based on specific criteria to interpret text and unstructured data using text processing software techniques. The interpretation of the text may be implemented using the models described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (e.g., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a computed probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corporate of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—e.g., ascertain or derive a new classification or subject, and not just classification into an existing subject or classification. Unsupervised learning software systems are also used for association rules mining to discover relationships between features from content data.

The content driver software service utilizes one or more supervised or unsupervised software processing techniques to perform a subject classification analysis to generate subject data. Suitable software processing techniques can include, without limitation, Latent Semantic Analysis, Probabilistic Latent Semantic Analysis, Latent Dirichlet Allocation. Latent Semantic Analysis software processing techniques generally process a corpus of alphanumeric text files, or documents, to ascertain statistical co-occurrences of words that appear together, which then give insights into the subjects of those words and documents. The content driver software service can utilize software processing techniques that include Non-Matrix Factorization, Correlated Topic Model (“CTM”), and K-Means or other types of clustering.

Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels, interrogatory labels, content source labels, or sentiment labels, thereby generating annotated training set content data. For example, a person can utilize a labeling software application to review training set content data to identify and tag or “annotate” various parts of speech, subjects, interrogatories, content sources, and sentiments.

The training set content data may then be fed to the content driver software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the computed probability and the known certainty. Then parameters to the neural network are adjusted (e.g., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic interaction between a provider agent and a user and designate such empty files as not suitable for use in a subject classification analysis. As another example, the qualification analysis can designate files below a certain size or having a shared experience duration below a given threshold (e.g., less than one minute) as also being unsuitable for use in the subject classification analysis.

The reduction analysis can also perform a contradiction operation to remove contradictions and punctuations from the content data. Contradictions and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contradictions can be replaced according to a standard library of known abbreviations, such as replacing the acronym “brb” with the phrase “be right back.” The contradiction operation can also remove or replace contractions, such as replacing “we're” with “we are.”

The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (e.g., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifiers in the content data (e.g., topics or subjects addressed in the content data) or interaction driver identifiers in the content data (e.g., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency-inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (e.g., topics) addressed within the content data. The subject classification analysis can specifically identify one or more interaction driver identifiers that are the reason why a user initiated a shared experience or support service request. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (e.g., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recomputed, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (e.g., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifiers.

The software model may be evaluated according to three categories, including a “good match” where the support request reason(s) are identified by the top words in the subject vector (e.g., the words with the highest weight or frequency), a “moderate” match where the support request reason(s) are identified by the second tier of words in the subject vector (e.g., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identifier, which is taken as subject weighting data. A similar analysis can be performed on vectors created through other processing, such as K-means clustering or techniques that generate vectors where each word in the vector is replaced with a probability that the word represents a subject identifier or request driver data.

To illustrate generating subject weighting data, for any given subject there may be numerous subject vectors. Assume that for most of subject vectors, the dot product will be close to zero—even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifiers may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are computed for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The content driver software service can also use term frequency-inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the content driver software service.

The content data can be visualized and subject to a reduction into two-dimensional data using a UMAP to generate a cluster graph visualizing a plurality of clusters. The content driver software service feeds the two-dimensional data into a DBSCAN and identify a center of each cluster of the plurality of clusters. The process may, using the two dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The content driver software service can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (e.g., a content source).

In instances where audio signals are being interpretated from audio files, video files, continual audio inputs (e.g., via a microphone), the system may apply binary time-frequency masks to separate signals from multiple sources by using a binary matrix to indicate which portions of a representation should be turned on or off. A binary mask includes a matrix of binary values that correspond to sources such that it is multiplied with a spectrogram to include or exclude portions of the audio. The binary time-frequency mask for each speaker or audio source is obtained using clustering that assigns the number “1” to all time-frequency bins corresponding to the respective speaker and assigning the number “0” to the remaining time-frequency bins. Inverse short time Fourier transform (STFT) may convert the obtained separated signals into a time domain for multiple downstream applications. Speech waveforms may be synthesized from the masked clusters where each waveform corresponds to a different source of the audio. Further, the speech waveforms may be combined to generate a mixed speech signal by stitching together the speech waveforms corresponding to the different sources. Advantageously, this process can be used to remove certain voices or background conversations from a recording where there are multiple sources of audio. Synthesizing speech waveforms from a cluster of numbers is not a process that can be practically performed in the human mind. By combining speech waveforms to generate a mixed speech signal by stitching together speech waveforms corresponding to different sources and excluding the sources that are undesired as either being undesired voices or background conversations. Advantageously, this can be used to isolate a desired source of audio as part of computer-based separation techniques to distinguish audio from different users. This can help the system accurately interpret the most relevant information to perform further analysis on the speech of the desired source of the audio.

The systems and methods disclosed herein may utilize deployed models such as the AI models 110 (e.g., machine learning models, neural networks, predictive models, etc.) to make predictions about customers having data in the aggregated data 108. The use of specially trained models realizes a number of improvements over traditional methods of making predictions, including more accurate budgets (e.g., the anticipated surplus of notification 520 and/or the anticipated shortfall of notification 522.) Further, the systems and methods disclosed herein lead to faster training times and a more accurate model.

The systems and methods disclosed herein reflect an improvement in the functioning of a computer or an improvement to other technology or a technical field. For example, the systems and method disclosed herein may improve the hub application 104, AI models 110, server 102, or any system that processes data to generate recommendations. For example, the AI models 110 may be trained based on the aggregated data 108, which allows the AI models 110 to generate improved recommendations, improved chat quality, etc.

FIG. 15 illustrates an example computing system 1500 suitable for implementing various embodiments as described herein. As shown, the computing system 1500 comprises a computer 1502, which is representative of any type of physical and/or virtualized computing device. Examples of the computer 1502 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1502 is representative of some or all of the components of the servers 102, user devices 112, and/or data sources 116. More generally, the computing system 1500 is configured to implement all systems, methods, apparatuses, media, and embodiments disclosed herein.

As shown, the computer 1502 includes one or more processors 1504, one or more memories 1506, one or more non-transitory storage media 1510, one or more communications interfaces 1512, one or more positioning devices 1514, one or more input devices 1516, and one or more output devices 1518 communicably coupled via an interconnect 1508. A power source 1520, such as a power supply, battery, or any type of power source may provide power to the computer 1502.

The processor 1504 is representative of any type of processing circuit. For example, the processor 1504 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1506 is representative of any computer readable medium to store data, code, or other information. The memory 1506 may include volatile memory, such as volatile Random Access Memory (RAM) including a cache area for the temporary storage of data. The memory 1506 may also include non-volatile memory, which can be embedded and/or may be removable. The non-volatile memory can additionally or alternatively include an electrically erasable programmable read-only memory (EEPROM), flash memory or the like. The storage medium 1510 is representative of any type of computer readable medium to store data, code, or other information. Examples of storage media 1510 include solid state drives, hard drives, Redundant Array of Independent Disks (RAID) drives, memory pools, universal serial bus (USB) storage devices, and the like.

The memory 1506 and storage medium 1510 can store any number and type of computer-executable instructions executed by the processor 1504 to implement the functions of the computer 1502 described herein. For example, the memory 1506 may include such applications as a web browser application and/or a mobile P2P payment system client application. These applications also typically provide a graphical user interface (GUI) on a display that allows the user to communicate with the computer 1502, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1506 and/or storage medium 1510 may be used to store data such as cached data, files for user accounts, user profiles, account balances, transaction histories, files downloaded or received from other devices, and any other data items.

The interconnect 1508 is representative of any type of circuitry to connect the components of the computer 1502. For example, the interconnect 1508 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1504 to the memory 1506, individual electrical connections among the components, and electrical conductive traces on a motherboard common to some or all of the above-described components of the computer 1502. As discussed herein, the interconnect 1508 may operatively couple various components with one another, or in other words, electrically connects those components, either directly or indirectly-by way of intermediate component(s)-with one another.

The one or more input devices 1516 are representative of any type of input device for receiving input, such as a keypad, keyboard, touchscreen, touchpad, microphone, camera, fingerprint sensor, mouse, joystick, other pointer device, button, soft key, and the like. The one or more output devices 1518 are representative of any type of device for outputting information, such as a monitor, speaker, haptic feedback module, printer, and the like.

The computer 1502 may use the communications interface 1512 to communicate with one or more other devices 1524 via a network 1522. The communications interface 1512 allows the computer 1502 to communicate with and conduct transactions with other devices and systems, such as the other devices 1524. The communications interface 1512 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 1512, which can be or include a radio-frequency transceiver, a Bluetooth device, Wi-Fi device, a Near-Field Communication (NFC) device, and other wireless transceivers. In addition, a positioning device 1514 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 1512, e.g., using USB, Ethernet, and other physically connected modes of data transfer. The network 1522 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1502 is configured to use the communications interface 1512 as, for example, a network interface to communicate with one or more other devices on a network such as network 1522. In this regard, the computer 1502 utilizes the wireless communications interface 1512 as an antenna operatively coupled to a transmitter and a receiver (together a “transceiver”) included with the communications interface 1512. The communications interface 1512 is configured to provide signals to and receive signals from the transmitter and receiver, respectively. The signals may include signaling information in accordance with the air interface standard of the applicable cellular system of a wireless telephone network. In this regard, the computer 1502 may be configured to operate with one or more air interface standards, communication protocols, modulation types, and access types. By way of illustration, the computer 1502 may be configured to operate in accordance with any of a number of first, second, third, fourth, fifth-generation communication protocols and/or the like. For example, the as a smartphone, the computer 1502 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1502 may also be configured to operate in accordance with non-cellular communication mechanisms, such as via a wireless local area network (WLAN) or other communication/data networks.

The communications interface 1512 may also include a payment network interface. The payment network interface may include software, such as encryption software, and hardware, such as a modem, for communicating information to and/or from one or more devices on a network. For example, the computer 1502 may be configured so that it can be used as a credit or debit card by, for example, wirelessly communicating account numbers or other authentication information to a terminal of the network. Such communication could be performed via transmission over a wireless communication protocol such as the NFC protocol.

The computer 1502 may be under the control of any suitable operating system (not pictured). Example operating systems include, but are not limited to, Linux® operating systems, UNIX®, Windows® operating systems, macOS®, iOS®, Android® and any other type of operating system.

The computer 1502 as illustrated diagrammatically represents at least one example of a possible implementation, where alternatives, additions, and modifications are possible for performing some or all of the described methods, operations, and functions. Although shown separately, in some embodiments, two or more computers 1502, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method for providing speech signal processing by an AI-based natural language hub, comprising:
accessing, by an application executing on processor, an internal account based on authentication information;
receiving, by the application, authentication information for a plurality of external accounts associated with a plurality of data sources;
receiving, by the application from the plurality of data sources, account data associated with the plurality of external accounts;
analyzing, by an artificial intelligence (AI) model executing on the processor, the account data received from the plurality of data sources and account data for the internal account;
generating, by the AI model based on the analysis, a first natural language recommendation and a second natural language recommendation;
outputting, by the application, the first natural language recommendation on a display; and
transmitting, by the application, the second natural language recommendation to another recipient.

2. The method of claim 1, wherein the first natural language recommendation is generated for an account holder of the internal account.

3. The method of claim 1, wherein the second natural language recommendation is generated for an entity providing the internal account.

4. The method of claim 1, further comprising prior to outputting the first natural language recommendation:
generating, by the application based on the account data received from the plurality of data sources and the account data for the internal account, a graphical user interface (GUI) comprising indications of the plurality of accounts and an indication of the internal account; and
displaying, by the application, the GUI on a display device.

5. The method of claim 4, wherein the first natural language recommendation is displayed in the GUI.

6. The method of claim 4, wherein the GUI comprises a first tab for the internal account and a second tab for the plurality of external accounts.

7. The method of claim 1, further comprising:
generating, by the application, a graphical user interface (GUI) comprising indications of a plurality of transactions reflected in the account data received from the plurality of data sources and the account data for the internal account.

8. The method of claim 1, further comprising:
determining, by the application based on the account data received from the plurality of data sources and the account data for the internal account, one or more outgoing transactions and one or more incoming transactions for a predetermined time period;
generating, based on the one or more outgoing transactions and the one or more incoming transactions, a budget for the predetermined time period;
generating, by the application, a graphical user interface (GUI) comprising an indication of the budget.

9. The method of claim 1, further comprising:
receiving, by the application from the plurality of data sources at predetermined time intervals, additional account data associated with the plurality of external accounts.

10. The method of claim 1, wherein at least a portion of the account data associated with the plurality of external accounts is received from one or more open banking application programming interfaces (APIs).

11. The method of claim 1, wherein the analyzing comprises:
classifying, by the AI model, a plurality of transactions in the account data associated with the plurality of external accounts; and
generating, by the AI model, the first natural language recommendation and the second natural language recommendation based at least in part on the classifications.

12. The method of claim 1, wherein the AI model comprises a natural language assistant configured to generate the first natural language recommendation and the second natural language recommendation.

13. The method of claim 1, further comprising:
identifying, by the application based on the account data received from the plurality of data sources and the account data for the internal account, a due date of a payment; and
outputting, by the application, a notification comprising an indication of the due date of the payment.

14. The method of claim 1, further comprising:
receiving, by the application, a request to initiate a communication session; and
initiating, by the application, the communication session.

15. The method of claim 1, further comprising:
receiving, by the application from the plurality of data sources, one or more attributes of one or more account holders associated with the external accounts.

16. The method of claim 1, prior to generating the first natural language recommendation:
receiving, by the application, speech input;
determining, by the AI model based on the speech input, a request to generate the first natural language recommendation, wherein the first natural language recommendation is generated based on the determined request.

17. The method of claim 1, further comprising:
determining, by the application, a plurality of transaction types; and
generating, by the application, graphical representations of the plurality of transaction types; and
outputting, by the application, the graphical representations in a graphical user interface (GUI).

18. The method of claim 1, further comprising:
determining, by the application based on the account data received from the plurality of data sources and the account data for the internal account, one or more outgoing transactions and one or more incoming transactions for a predetermined time period;
generating, based on the one or more outgoing transactions and the one or more incoming transactions, a projected cashflow for the predetermined time period;
generating, by the application, a graphical user interface (GUI) comprising an indication of the projected cashflow.

19. A non-transitory computer-readable storage medium, the computer-readable storage medium including instructions that when executed by a processor, cause the processor to:
access, by an application, an internal account based on authentication information;
receive, by the application, authentication information for a plurality of external accounts associated with a plurality of data sources;
receive, by the application from the plurality of data sources, account data associated with the plurality of external accounts;
analyze, by an artificial intelligence (AI) program executing on the processor, the account data received from the plurality of data sources and account data for the internal account;
generate, by the AI model based on the analysis, a first natural language recommendation and a second natural language recommendation;
output, by the application, the first natural language recommendation on a display; and
transmit, by the application, the second natural language recommendation to another recipient.

20. An apparatus, comprising:
a processor; and
a memory storing instructions that, when executed by the processor, cause the processor to:
access, by an application, an internal account based on authentication information;
receive, by the application, authentication information for a plurality of external accounts associated with a plurality of data sources;
receive, by the application from the plurality of data sources, account data associated with the plurality of external accounts;
analyze, by an artificial intelligence (AI) program executing on the processor, the account data received from the plurality of data sources and account data for the internal account;
generate, by the AI model based on the analysis, a first natural language recommendation and a second natural language recommendation;
output, by the application, the first natural language recommendation on a display; and
transmit, by the application, the second natural language recommendation to another recipient.
